(19) United States
(12) Patent Application Publication
(10) Pub. No.: US 2010/0125532 A1
(43) Pub. Date: May 20, 2010

(54) METHOD AND APPARATUS FOR MODELING ECONOMIC CONDITIONS AS APPLIED TO MULTIPLE RISK GRADES

(76) Inventors: MICHAEL COHEN, Denver, CO (US); Gary J. Sullivan, San Francisco, CA (US); Chenyang Lian, El Cerrito, CA (US)

Correspondence Address: MINTZ, LEVIN, COHN, FERRIS, GLOVSKY AND POPEO, P.C, ONE FINANCIAL CENTER, BOSTON, MA, 02111, US

(21) Appl. No.: 12/275,017

(22) Filed: Nov. 20, 2008

(51) Int. Cl. G06Q 40/00

(52) U.S. Cl. 705/36 R; 705/35

(57) ABSTRACT

A computerized method includes scoring a plurality of loans, and banding the plurality of loans into risk pools on the basis of the scores associated with the plurality of loans. The computerized method also includes modeling a change in y-intercept and slope of the natural log of the odds to the loan scores relationship, using that predicted log odds to calculate the probability of default for the plurality of risk pools over time as a function of a set of macro-economic data. A machine readable medium provides instructions that, when executed by a machine, cause the machine to perform the above on a system for determining an amount of capital to hold in reserve for a plurality of loan risk pools and to set strategies for managing risk for a plurality of risk pools.

### TECHNICAL FIELD

Various embodiments described herein relate to apparatus, systems, and methods for a method and apparatus for modeling the impact of economic conditions to multiple risk grades in a lending environment.

### BACKGROUND INFORMATION

Banking laws and regulations protect customer's deposits and, hopefully, insure the vitality of various banking institutions. Various banking laws exist in various countries around the world. In the past 30-40 years, laws and regulations have been put in place to govern banks on an international basis rather than just a local basis. This has become even more common along with the realization that all economies are tied to the world economy.

One set of international laws and regulations is the Basel Accord. In June 2004, Basel II was published as the second revision of the Basel Accord. The Basel Accord includes recommendations on banking laws and regulations issued by the Basel Committee on Banking Supervision. The purpose of Basel II is to create an international standard that banking regulators can use when creating regulations about how much capital banks need to put aside to guard against the types of financial and operational risks banks face. Advocates of Basel II believe that such an international standard can help protect the international financial system from the types of problems that might arise should a major bank or a series of banks collapse. In practice, Basel II attempts to accomplish this by setting up rigorous risk and capital management requirements designed to ensure that a bank holds capital reserves appropriate to the risk the bank exposes itself to through its lending and investment practices. Generally speaking, these rules mean that the greater risk to which the bank is exposed, the greater the amount of capital the bank needs to hold to safeguard its solvency and overall stability.

One aim of the Basel II Accord is to ensure that capital allocation is more sensitive to risk. In most banking institutions, banks divide each portfolio of loans into bands that are called Basel risk grades (bins). The population bands or Basel risk grades are frequently defined by binning accounts by a risk score band.

As the economy within a country or the global economy rises and falls, the risk associated with the various risk pools changes. Regulators, such as regulators that use the Basel II Accord, want to account for the changes in the economy when assessing risk with respect to the risk bands or risk pools, and insure that the capital reserved will be adequate throughout an economic cycle. Variations in the overall economy impact how the risk evolves in each risk grade. To determine how the risk changes in response to changes in the economy, a common approach is to build economic models for each bin or Basel risk grade. However, if a banking institution has many risk grades, this could result in the need to build many different models. There could also be differences in the models which may be questioned by regulators using the Basel II Accord. Such a scheme would be resource intensive and adds dramatically to the cost of a project for a particular lending institution.

### BRIEF DESCRIPTION OF THE DRAWINGS

FIG. 1 is a block diagram of a system that is used to determine an amount of capital to hold in reserve for a plurality of loan risk pools, according to an example embodiment.

FIG. 2 is a block diagram of an example modeling component used in at least one embodiment of the system of FIG. 1, according to an example embodiment.

FIG. 3 a computerized method for determining an amount of capital to hold in reserve for a plurality of loan risk pools, according to an example embodiment.

FIG. 4 shows a new PD verses an old PD that results from a linear shift in the linear log-odds to score relationship, according to an example embodiment.

FIG. 5 a computerized method for determining a model used to determine various strategies related to risks, such as determining an amount of capital to hold in reserve for a plurality of loan risk pools, according to an example embodiment.

FIG. 6 is a machine or computer-readable media that includes a set of instructions, according to an example embodiment.

FIG. 7 a computerized method for determining a model used to determine various strategies related to risks, such as determining an amount of capital to hold in reserve for a plurality of loan risk pools, according to another example embodiment.

### DETAILED DESCRIPTION

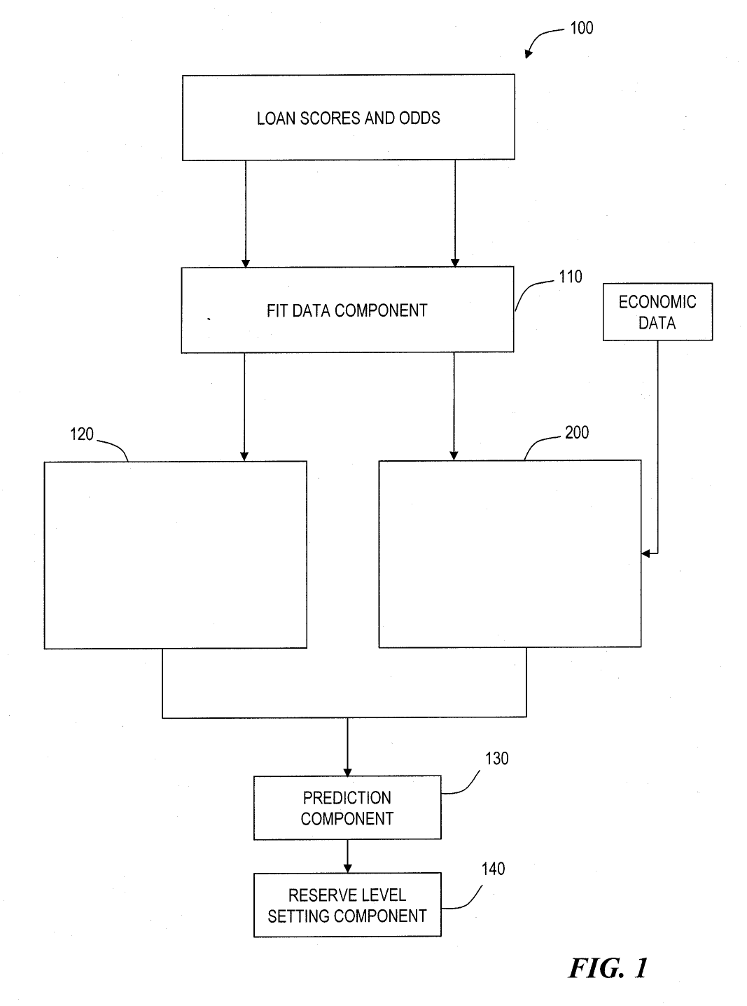

FIG. 1 is a block diagram of a system 100 that is used to determine an amount of capital to hold in reserve for a plurality of loan risk pools, according to an example embodiment. The system 100 includes a first model component 120 for fitting the odds associated with the plurality of loan scores by using a linear function relating the natural log of the odds to a risk score. The system 100 also includes a second model component 200 for producing a model of the change in intercept over time as a function of a set of macro-economic data. In this model, the change in y-intercept of the linear function accounts for changes, including economic changes, that affect the relationship between a score and the natural log of the odds. The system also includes a fit component 110 for fitting the log of the odds to score relationship at several points in time. This fitting is used to obtain intercept and slope statistics for a number of points in time. The system 100 also includes a prediction component 130 for predicting the odds in a plurality of risk pools under current or future economic conditions using the predicted intercept from component 200 and the odds to score relationship. The system also includes a reserve level component 140 for setting a reserve level for at least one risk pool in a lending institution which has a plurality of risk pools of loans which they have given to borrowers. In some embodiments, the reserve level component 140 sets reserve levels in at least two of the plurality of risk pools. Other embodiments of the system further include a third modeling component for modeling the variation in the slope in the relationship of the natural log of the odds verses loan risk scores.

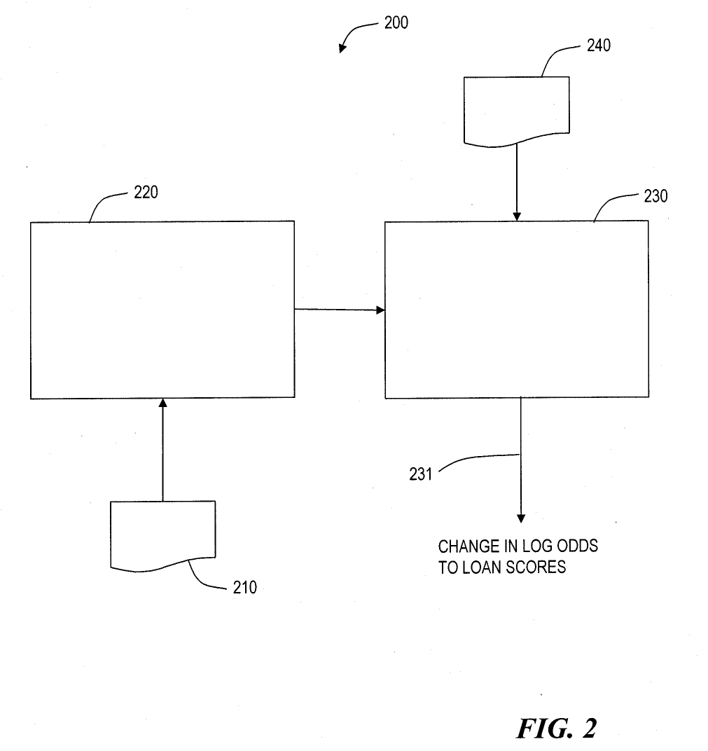

FIG. 2 is a block diagram of an example modeling component 200 used in at least one embodiment of the invention of the system 100. The modeling component 200 includes a learning component 220 and a predictive component 230. The learning component 220 processes historical data 210 and recognizes various patterns. In this particular system, the historical data 210 is economic data. The economic data includes economic indicators such as the Gross Domestic Product (GDP), the unemployment rate, selected interest rates, or the like. The pattern to which the historical data is being correlated includes, in one embodiment, the shift in the Y-intercept of a the linear model relating a credit score to the log of odds on a plurality of loans, and the corresponding impact when the log of odds is translated into the probability of default (PD) on a plurality of loans.

The predictive component 230 has an output 231 which is used to determine a probability of default for a plurality of risk pools of loans. The output 231 from the learning component 220 is a model that can be used with substantially real time economic data or a projection of economic data 240 to predict a shift in the y-intercept of a linear function relating the risk score on the pool of loans to the log odds on that pool of loans, that can then be translated into the probability of default in a plurality of banded risk pools of loans. The output 231 of the prediction component 230 is used to predict the y-intercept of the line associated with the natural log of the odds to the credit score of a plurality of borrowers for a number of pools of loans. Once the y-intercept of the line associated with the natural log of the odds to the credit scores of a plurality of borrowers is found, the log odds can be transformed into the PD (probability of default). Given the PD, regulators or the lenders themselves, can set aside a selected reserve amount. As mentioned previously, the reserve level component sets reserve levels in at least two of the plurality of risk pools.

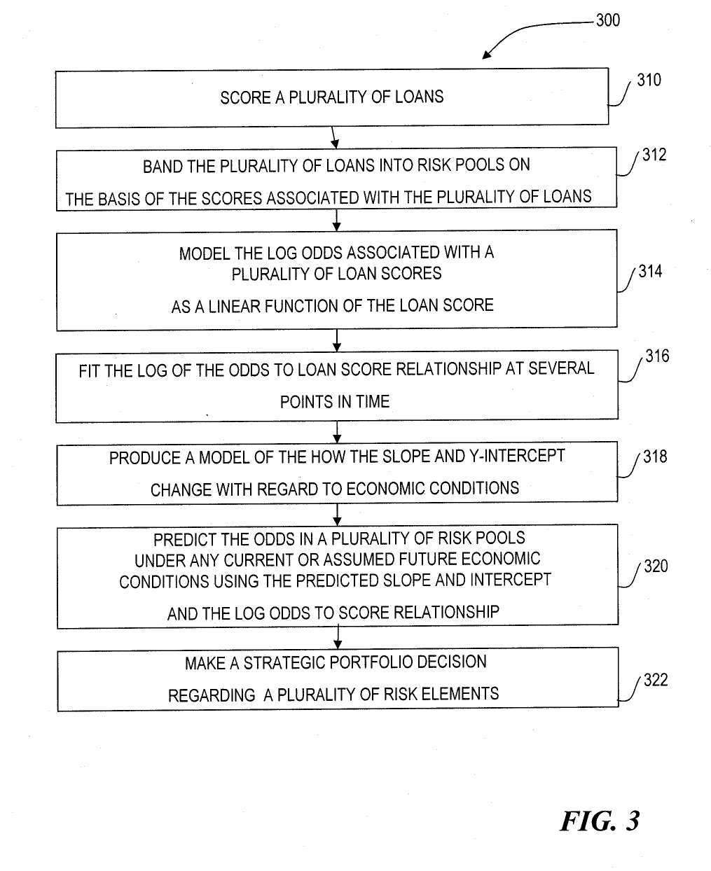

FIG. 3 is a flow chart of a computerized method 300 for determining an amount of capital to hold in reserve for a plurality of loan risk pools, according to an example embodiment. The method 300 includes scoring a plurality of loans 310, banding the plurality of loans into risk elements, such as risk pools, on the basis of the scores associated with the plurality of loans 312, and modeling the log odds associated with a plurality of loan scores as a linear function of the loan score 314. The y-intercept and slope of the linear function accounts for changes, including economic changes, that effect the natural log of the odds. The computerized method also includes fitting the log of the odds to loan score relationship at several points in time 316, to obtain intercept and slope statistics at each point in time, producing models of the how the slope and y-intercept change with regard to economic conditions 318, predicting the odds in a plurality of risk pools under any current or assumed future economic conditions using the predicted slope and intercept and the log odds to score relationship 320, and making strategic portfolio decisions 322, such as setting a reserve level for a plurality of risk pools using the predicted log odds to score relationship. Of course there are other strategic portfolio decisions that can be made including account acquisitions decisions, prospective odds to score relationship management, account management decisions, and the like. The account management decisions, may also include credit Line Increase/decrease decisions, overlimit and delinquent authorization decisions, and collections and recovery decisions. In some embodiments, producing models of the how the slope and y-intercept change with regard to economic conditions 318 further includes calculating the average slope over time, assuming that this average slope is a fixed slope in the odds to score relationship over all points in time, obtaining the best fit intercept at each point in time using this average slope, and modeling the changes in the y-intercept obtained based on the fixed slope.

The GDP is one type of economic data that can be selected for the model. It is contemplated that there may be other economic indicators that could be used as a variable to reflect this relationship. It is further contemplated that there may be combinations of economic indicators that could be used as variables in order to model the shift in the linear function of log of the odds verses the credit score of the borrowers to changes in the economy. The GDP, unemployment rates, and key interest rates are just some of the types of economic data that could be used in the model. Various institutions, such as various banks or other lenders, can develop different models based on one or more economic variables. Once the model is generated, it is then used to forecast, based on current or future economic factors, the y-intercept of the linear function of log of the odds verses the credit scores of the borrowers. The result is that the risk estimate for a plurality of risk pools includes a shift in the risk due to a forward-looking estimate of economic factors. Given this, a calculation of a reserve amount a lender needs for one or more risk pools can be calculated. The capital needed in the upcoming cycle can then be set aside.

The model is found for the entire portfolio. The loans are graded by risk. The risk grades are defined by score bins, from a score developed via any methodology where the score has a log-linear relationship to the dichotomous target, such as using logistic regression, or Scorecard Module technology, available from Fair Isaac Corporation, 901 Marquette Avenue, Suite 3200, Minneapolis, Minn. 55402-3232 USA. Scorecard Module is one example of a statistical tool that results in a linear relationship between the model outcome and the log odds of the dichotomous performance outcome. Of course, there may be other, statistical tools available that similarly produce models which have log-linear relationships to the target variable. The bins are based on fixed score ranges, that do not vary over time. Therefore, an average/midpoint score for each bin is calculated.

As mentioned previously, the scores are linear in log-odds. Stated differently, at every point in time i, the following relationship is seen:

ln(odds)=mᵢs+kᵢ

Where mᵢ is the slope at time i and kᵢ is the intercept at time i.

Thus, by building economic models to predict how m and k evolve with respect to economic conditions, the risk in each bin based on this odds to score relationship, based on the average score in each bin can be estimated.

In one embodiment, it is assumed that m is constant over time. As a result, one model is built to understand how the risk evolves in all of the various risk grades.

The odd to score relationship for the PD score is calculated for each point in time for which there is data. From this, a constant slope is determined, and a least-squares regression methodology is used to fit the constant slope line and determine a y-intercept. An overview of this method includes trimming, the data, binning the data, and fitting the data.

To avoid giving outliers too much emphasis, the edges of the data are trimmed. In one embodiment, an inner trim approach is used. The score distributions on the “goods” and “bads” are separately observed. The high-end cut off is the score where only 5% of the bads score higher, and the low-end cut-off is the score where only 5% of the good score lower. This ensures that there are robust counts of both goods and bads in the area where the fit is calculated, and provides a good confidence in the resulting fit. In another embodiment, one could perform an outer trim, where the lower 5% of bad and the highest 5% of goods are removed. However, the outer trim technique may lead to poor fits due to low counts of bads in the high score areas and low counts of goods in low score areas.

After trimming, the resulting data is placed into 8-10 equal population sized bins. Note that, for this calculation purpose, these bins do not have to correspond to the bins for the risk grades. The odds and natural log odds are calculated in each bin.

Default rate by risk grade

| | Score | | | | | | | | | | | | |
|---|---|---|---|---|---|---|---|---|---|---|---|---|---|
| | 1430- | 1414- | 1408- | 1390- | | | | | | | | | |
| Quarter | High | 1429 | 1413 | 1407 | 1376-1389 | 1370-1375 | 1362-1369 | 1352-1361 | 1342-1351 | 1320-1341 | 1296-1319 | Low-1295 | Total |
| May-02 | 0.14% | 0.64% | 0.57% | 1.00% | 3.0% | 3.7% | 5.5% | 6.7% | 8.7% | 16.9% | 36.3% | 75.9% | 2.8% |
| Aug-02 | 0.17% | 0.43% | 0.88% | 1.29% | 1.7% | 2.9% | 5.5% | 10.1% | 15.0% | 18.6% | 43.6% | 75.6% | 2.8% |
| Nov-02 | 0.09% | 0.46% | 1.03% | 1.02% | 1.9% | 4.6% | 3.5% | 7.9% | 8.9% | 21.2% | 52.3% | 74.5% | 2.7% |
| Feb-03 | 0.16% | 0.33% | 0.66% | 1.42% | 2.2% | 2.0% | 4.1% | 5.0% | 9.9% | 18.7% | 39.5% | 71.1% | 2.7% |
| May-03 | 0.15% | 0.32% | 0.29% | 0.61% | 1.7% | 3.8% | 4.5% | 6.7% | 12.0% | 17.3% | 44.0% | 73.3% | 2.6% |
| Aug-03 | 0.19% | 0.34% | 0.84% | 0.81% | 2.2% | 3.7% | 4.0% | 4.4% | 11.5% | 9.6% | 36.5% | 68.5% | 2.4% |
| Nov-03 | 0.10% | 0.43% | 0.38% | 0.99% | 2.0% | 3.1% | 3.3% | 5.0% | 11.0% | 16.3% | 44.0% | 66.4% | 2.3% |
| Feb-04 | 0.15% | 0.44% | 0.62% | 0.70% | 1.3% | 2.2% | 3.1% | 6.4% | 8.3% | 14.7% | 32.4% | 64.9% | 2.2% |
| May-04 | 0.12% | 0.45% | 0.39% | 1.45% | 2.4% | 4.0% | 5.4% | 7.8% | 10.9% | 20.5% | 36.4% | 70.9% | 2.3% |
| Aug-04 | 0.14% | 0.50% | 0.99% | 1.20% | 2.7% | 3.2% | 4.8% | 5.9% | 10.0% | 14.0% | 35.9% | 67.8% | 2.4% |
| Nov-04 | 0.18% | 0.40% | 0.60% | 1.55% | 2.0% | 3.8% | 6.9% | 5.9% | 10.7% | 22.5% | 40.7% | 75.7% | 2.4% |
| Feb-05 | 0.19% | 0.52% | 1.04% | 1.14% | 2.9% | 5.1% | 5.0% | 9.7% | 14.2% | 20.2% | 36.4% | 72.0% | 2.6% |
| May-05 | 0.15% | 0.56% | 1.07% | 1.31% | 3.3% | 4.6% | 4.8% | 6.5% | 15.0% | 20.8% | 48.2% | 76.5% | 2.7% |
| Aug-05 | 0.13% | 0.50% | 1.05% | 1.49% | 2.2% | 5.2% | 4.4% | 7.6% | 10.3% | 23.0% | 38.3% | 74.1% | 2.7% |
| Nov-05 | 0.15% | 0.48% | 0.90% | 1.43% | 3.5% | 3.1% | 4.2% | 8.4% | 16.3% | 27.8% | 45.9% | 78.0% | 2.7% |
| Jan-06 | 0.12% | 0.49% | 1.05% | 1.53% | 2.5% | 4.0% | 4.7% | 5.1% | 17.7% | 22.0% | 46.9% | 77.5% | 2.5% |
| Mar-06 | 0.08% | 0.49% | 0.87% | 1.56% | 2.7% | 3.1% | 3.9% | 4.2% | 18.7% | 25.2% | 44.2% | 76.3% | 2.5% |
| May-06 | 0.04% | 0.37% | 1.48% | 1.64% | 2.6% | 5.6% | 9.2% | 10.0% | 15.4% | 28.3% | 26.6% | 72.6% | 2.7% |
| LR PD | 0.1% | 0.5% | 0.8% | 1.2% | 2.4% | 3.8% | 4.8% | 6.9% | 12.5% | 19.9% | 40.4% | 72.9% | 2.6% |
| Worst | 0.2% | 0.6% | 1.5% | 1.6% | 3.5% | 5.6% | 9.2% | 10.1% | 18.7% | 28.3% | 52.3% | 78.0% | 2.8% |
| PD | | | | | | | | | | | | | |

Log Odds by risk grade

| | Score | | | | | | | | | | | | |
|---|---|---|---|---|---|---|---|---|---|---|---|---|---|
| | | | 1408- | 1390- | | | | | | | | | |
| Quarter | 1430-High | 1414-1429 | 1413 | 1407 | 1376-1389 | 1370-1375 | 1362-1369 | 1352-1361 | 1342-1351 | 1320-1341 | 1296-1319 | Low-1295 | Total |
| May-02 | 6.54 | 5.04 | 5.16 | 4.60 | 3.48 | 3.27 | 2.84 | 2.63 | 2.35 | 1.59 | 0.56 | (1.15) | 3.53 |
| Aug-02 | 6.40 | 5.44 | 4.73 | 4.34 | 4.04 | 3.52 | 2.84 | 2.18 | 1.74 | 1.48 | 0.26 | (1.13) | 3.56 |
| Nov-02 | 6.97 | 5.39 | 4.57 | 4.58 | 3.95 | 3.04 | 3.31 | 2.45 | 2.33 | 1.32 | (0.09) | (1.07) | 3.57 |
| Feb-03 | 6.46 | 5.70 | 5.01 | 4.24 | 3.81 | 3.91 | 3.16 | 2.95 | 2.21 | 1.47 | 0.43 | (0.90) | 3.58 |
| May-03 | 6.48 | 5.73 | 5.83 | 5.09 | 4.04 | 3.24 | 3.07 | 2.64 | 1.99 | 1.57 | 0.24 | (1.01) | 3.64 |
| Aug-03 | 6.28 | 5.69 | 4.77 | 4.81 | 3.78 | 3.26 | 3.18 | 3.07 | 2.04 | 2.24 | 0.55 | (0.77) | 3.69 |
| Nov-03 | 6.95 | 5.45 | 5.58 | 4.60 | 3.90 | 3.44 | 3.37 | 2.95 | 2.09 | 1.64 | 0.24 | (0.68) | 3.73 |
| Feb-04 | 6.47 | 5.41 | 5.07 | 4.95 | 4.35 | 3.78 | 3.43 | 2.68 | 2.41 | 1.75 | 0.73 | (0.61) | 3.79 |
| May-04 | 6.69 | 5.40 | 5.54 | 4.22 | 3.72 | 3.17 | 2.87 | 2.46 | 2.10 | 1.35 | 0.56 | (0.89) | 3.75 |
| Aug-04 | 6.54 | 5.30 | 4.61 | 4.41 | 3.59 | 3.40 | 2.98 | 2.76 | 2.20 | 1.81 | 0.58 | (0.74) | 3.72 |
| Nov-04 | 6.32 | 5.53 | 5.12 | 4.15 | 3.88 | 3.24 | 2.60 | 2.77 | 2.12 | 1.24 | 0.38 | (1.14) | 3.70 |
| Feb-05 | 6.24 | 5.25 | 4.55 | 4.47 | 3.50 | 2.93 | 2.95 | 2.23 | 1.79 | 1.37 | 0.56 | (0.95) | 3.62 |
| May-05 | 6.53 | 5.18 | 4.52 | 4.32 | 3.37 | 3.03 | 2.99 | 2.67 | 1.73 | 1.34 | 0.07 | (1.18) | 3.57 |
| Aug-05 | 6.62 | 5.29 | 4.54 | 4.19 | 3.81 | 2.91 | 3.08 | 2.49 | 2.16 | 1.21 | 0.48 | (1.05) | 3.57 |
| Nov-05 | 6.52 | 5.34 | 4.70 | 4.23 | 3.31 | 3.45 | 3.13 | 2.39 | 1.63 | 0.95 | 0.16 | (1.27) | 3.58 |
| Jan-06 | 6.70 | 5.31 | 4.54 | 4.17 | 3.66 | 3.17 | 3.00 | 2.91 | 1.54 | 1.27 | 0.13 | (1.24) | 3.67 |
| Mar-06 | 7.09 | 5.31 | 4.73 | 4.15 | 3.60 | 3.43 | 3.20 | 3.11 | 1.47 | 1.09 | 0.23 | (1.17) | 3.65 |
| May-06 | 7.93 | 5.59 | 4.20 | 4.09 | 3.61 | 2.83 | 2.29 | 2.20 | 1.70 | 0.93 | 1.02 | (0.97) | 3.60 |

From the data in the table above, the log-odds to score are fit in each cell. This results in a table below in which, for each time that historical results are available, the fit line has a slope and a y-intercept.

| | slope | Intercept |
|---|---|---|
| May-02 | 0.041381 | −53.5055 |
| Aug-02 | 0.045438 | −59.1576 |
| Nov-02 | 0.045755 | −59.564 |
| Feb-03 | 0.044438 | −57.5554 |
| May-03 | 0.051208 | −66.7704 |
| Aug-03 | 0.041670 | −53.7168 |
| Nov-03 | 0.046842 | −60.8099 |
| Feb-04 | 0.042976 | −55.3851 |
| May-04 | 0.045131 | −58.655 |
| Aug-04 | 0.039516 | −50.9391 |
| Nov-04 | 0.045316 | −58.9447 |
| Feb-05 | 0.041979 | −54.5179 |
| May-05 | 0.043406 | −56.5087 |
| Aug-05 | 0.041696 | −54.0731 |
| Nov-05 | 0.045873 | −59.8799 |
| Jan-06 | 0.044119 | −57.4384 |
| Mar-06 | 0.044653 | −58.106 |
| May-06 | 0.040881 | −53.1278 |

In some embodiments of the invention, the data used is the default rate by risk grade. This information is used in place of the trimmed data above. An average score within each risk grade is used in the calculation.

Given the above data, the y-intercept is calculated assuming a fixed slope. The average slope is calculated by calculating the average of the slopes across the data. In the above example, the average slope is 0.044015 is called the fixed slope m.

For each point in time, the y-intercept that creates the best fit with the data is calculated, given the average, observed slope. This is accomplished by performing a least-squares regression fit on the log(odds) given the fixed slope. In other words, the value of k (k=the y-intercept) that minimizes the following equation is the one corresponding to the least-squares regression fit.

$${\sum }_{risk bands j} ‖ ( observed ln ( odds ) - ( {ms}_{j} + k ) ‖$$

Where sⱼ is the mean score in risk band j. This is done for substantially all points in time i to obtain a vector of intercepts kᵢ. In this example, the following data is obtained:

| | intercept |
|---|---|
| | with fixed |
| | slope |
| May-02 | −57.1242 |
| Aug-02 | −57.2346 |
| Nov-02 | −57.1905 |
| Feb-03 | −57.0502 |
| May-03 | −56.9507 |
| Aug-03 | −56.9378 |
| Nov-03 | −56.9667 |
| Feb-04 | −56.8087 |
| May-04 | −57.1383 |
| Aug-04 | −57.1629 |
| Nov-04 | −57.1597 |
| Feb-05 | −57.339 |
| May-05 | −57.362 |
| Aug-05 | −57.2638 |
| Nov-05 | −57.3728 |
| Jan-06 | −57.3979 |
| Mar-06 | −57.2386 |
| May-06 | −57.3956 |

Once this time series has been obtained, the next step is to build an economic model to fit this data. The model obtained relates the y-intercept of the natural log of the odds to score to one or more economic variable. As a result, the model, stated mathematically, is k=k(\vec{e}), where \vec{e} is a vector of one or more economic variables. Once the model k(\vec{e}) is obtained, and given the midpoint of each score range, and knowing that the slope of the linear function of the natural log of the odds to the credit scores of the borrowers is assumed to be constant, the natural log of the odds to the credit scores of the borrowers under these assumed economic conditions can be determined from the y-intercept. Given this natural log of odds, the PD of the borrowers can be determined as well.

This methodology can be applied in multiple ways. Several regulators implementing Basel II accord mandate that the institution understand the “long run average” amount of risk in their portfolio, which needs to be “forward looking”. Forward looking means that they must assume what the upcoming economic conditions would be. An institution could use this methodology to calculate risk as follows:
Different institutions may generate different sets of economic conditions \vec{e}ᵢ that they believe to be a reasonable set of “forward looking” economic conditions over an upcoming cycle. At a minimum, a projected peak and trough of the economic cycle, could be used to extrapolate out other points in the economic cycle. This could be done by looking at historical cycles and judging the duration of a standard cycle. Historical data could also be used to project out what a conservative peak and trough would be.

Consideration must also be given regarding an appropriate length of an economic cycle, including the length of the trough. For example, if a downturn might last longer than historical cycles, that needs to be taken into account in a model. Once the set of economic factors \vec{e}ᵢ has been created, for each risk bin j and point in the economic cycle i, the long-run average default rate in each bin as follows:

$$ln ( {odds}_{ij} ) = {ms}_{j} + k ( {\vec{e}}_{i} )$$

$${PD}_{ij} = 1 / ( 1 + {odds}_{ij} )$$

$${( long \text{-} run odds )}_{j} = {average}_{i} ( {PD}_{ij} )$$

Where sⱼ is the mean score for each risk band j

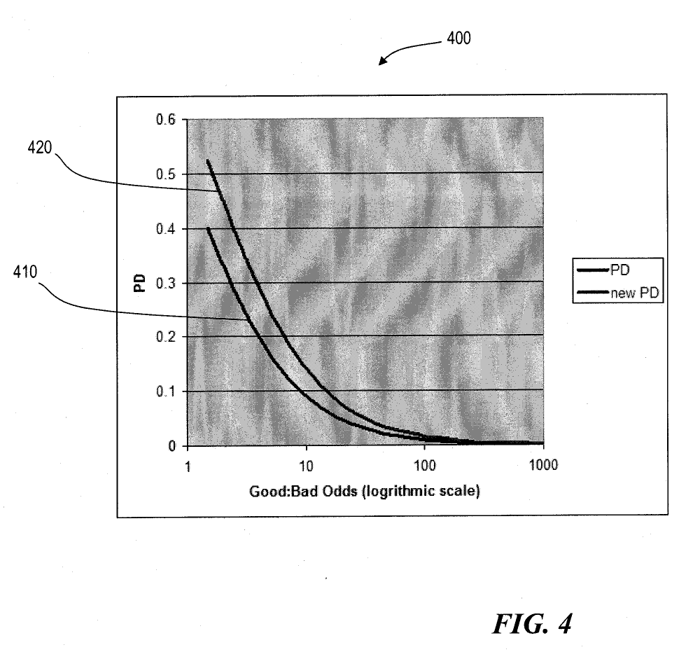

FIG. 4 shows a chart 400 that plots the PD (y-axis) with respect to the good: bad odds (x-axis), according to an example embodiment. The chart 400 includes a first or old PD 410 and a new PD 420. The new PD 420 is the result of shifting the linear log-odds to score line as discussed in the example above. Note that although this is a linear shift in the linear log-odds to score relationship, there is a non-linear relationship with respect to the PD.

Institutions under the Basel accord are also frequently required to calculate the amount of risk in each risk grade during a downturn. This can be calculated as follows:
Given the model k(\vec{e}), and the midpoint of each score range is found. Upon identifying an appropriate set of downturn economic conditions \vec{e}, generate the downturn PD in each risk bin as:

ln(oddsⱼ)=msⱼ+k(\vec{e})

PDⱼ=1/(1+oddsⱼ)

This approach can be extended to predict the impact of economics on continuous outcome variables as well as dichotomous good/bad outcomes. This is done by translating the continuous variable into a dichotomous variable, using a process known as “parcelling.” The parcelling methodology defines statistics min and max, which are trimmed lower and upper bounds of the continuous variable to predict. Then, for each exemplar to predict the continuous outcome variable of, two copies of the exemplar are created, one with a dichotomous outcome of “good” with sample weight reflective of the distance min, and one with an outcome of “bad”, with sample weight reflective of the difference from max. Using this data to create a dichotomous model, we can then see the following relationship between the score and the original target y is as follows:

$$ln ( \frac{{\overline{y}}_{j} - min}{max - {\overline{y}}_{j}} ) = m {\overline{S}}_{j} + k$$

Where Sⱼ is the average score in risk band j, and yⱼ is the observed value of the continuous variable, such as EAD or LGD.

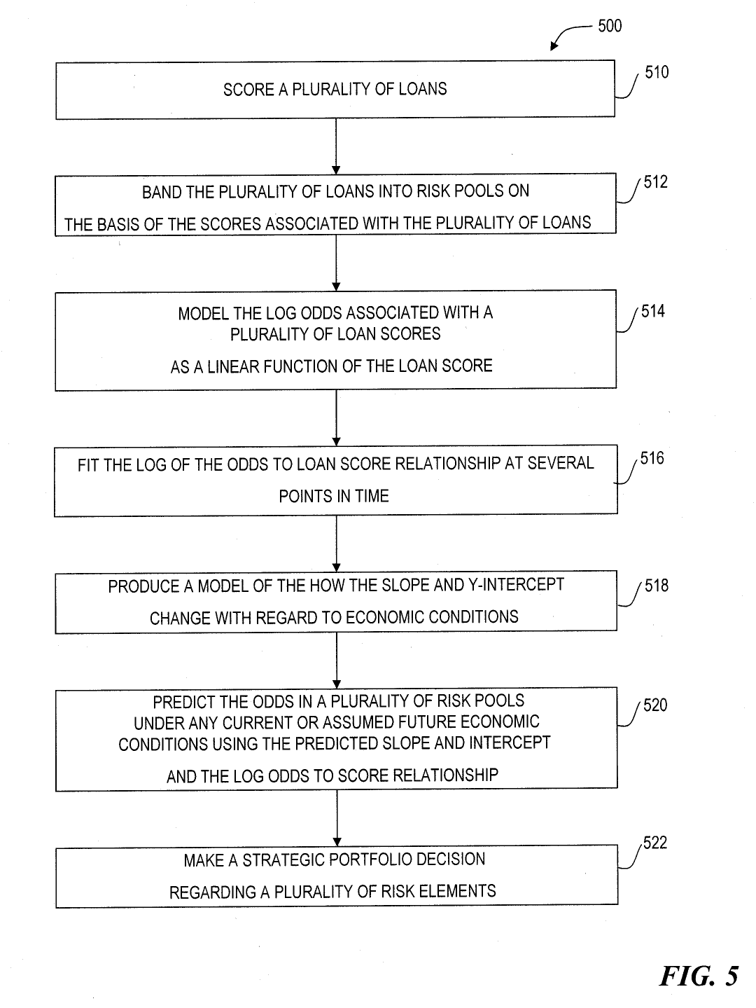

In the above example embodiment, the slope of the function relating the natural log of the odds associated with a plurality of loan scores was assumed to be constant over time. There is a second embodiment where the both the slope and intercept are assumed to vary with regard to economic conditions. FIG. 5 is a flow chart of a computerized method 500 for determining an amount of capital to hold in reserve for a plurality of loan risk pools, according to an example embodiment. The method 500 includes scoring a plurality of loans 510, banding the plurality of loans into risk pools on the basis of the scores associated with the plurality of loans 512, and modeling the log odds associated with a plurality of loan scores as a linear function of the loan score 514. The y-intercept and slope of the linear function accounts for changes, including economic changes, that effect the natural log of the odds. The computerized method also includes fitting the log of the odds to loan score relationship at several points in time 516, to obtain intercept and slope statistics at each point in time, producing models of the how the slope and y-intercept change with regard to economic conditions 518, predicting the odds in a plurality of risk pools under any current or assumed future economic conditions using the predicted slope and intercept and the log odds to score relationship 520, and making strategic portfolio decisions 522, such as setting a reserve level for a plurality of risk pools using the predicted log odds to score relationship. As mentioned previously, there are other strategic portfolio decisions that can be made including account acquisitions decisions, prospective odds to score relationship management, account management decisions, and the like. The account management decisions, may also include credit Line Increase/decrease decisions, overlimit and delinquent authorization decisions, and collections and recovery decisions. In some embodiments, producing models of the how the slope and y-intercept change with regard to economic conditions 518 further includes translating the slope and intercept changes into translational and rotational changes over time, modeling of the change in translational and rotational components as a function of a set of macro-economic data, obtaining the slope and intercept as functions of economic data from the translational and rotational models, and predicting the intercept and slope under various economic conditions using the model for the change in translational and rotational components as a function of a set of macro-economic data.

The predicted odds associated with a plurality of loan scores is expressed as a linear function relating the natural log of the odds to a risk score on the loans in the plurality of risk pools. Fitting the log of the odds to score relationship includes using a linear regression, or a logistic regression. The set of data used in modeling the movement of the linear function may includes one or more of the following: Gross Domestic Product (GDP), a set of interest rates over time, a set of unemployment rates, or a set of personal savings rates.

In still another embodiment, the computerized method of further includes calculating the average intercept over time, and assuming that this average intercept is a fixed intercept in the odds to score relationship over all points in time. The best fit slope at each point in time using this average intercept is obtained, and the changes in the slope obtained based on this fixed y-intercept are modeled.

In this embodiment, the main idea is that the shift in the log odds to the plurality of loan score relationship over time is composed of both a translational and a rotational component. The change in slope is due to the rotational component, the change in y-intercept is due to both the rotational and translational component. This translational and rotational component, and hence the y-intercept and the slope, account for changes, including economic changes, that affect the natural log of the odds.

The slope and intercept of the log of odds to scores relationship are correlated. A change in slope also creates a change in the y-intercept. However, not all changes in the y-intercept are caused by slope changes. Some of the changes in the y-intercept are due to a shift or translation of the linear function of the log of the odds to scores relationship. Therefore, in order to distinguish between these effects, one must distinguish between rotation of the linear function (i.e. a change in slope), and translation of the linear function (a change in intercept unconnected with a change in slope). Therefore, the slope intercept pairs need to be decomposed so as to separate the effects of translation from the effects of rotation and to obtain pairs for rotation and translation that are uncorrelated to each other.

In order to accomplish a decomposition of the translation of the linear function from the rotation of the linear function, portfolio data from a number of time periods, t, and calculate the slope, m, and intercept, b, is collected from the portfolio data. Using the regression methods for each of the slope (m) and the y-intercept (b), the standardized versions of each can be calculated as follows:

$${m}_{z} ( t ) = \frac{m ( t ) - \overline{m}}{{\hat{σ}}_{m}} where \overline{m} = \frac{1}{T} {\sum }_{t = 1}^{T} m ( t ) and$$

$${\hat{σ}}_{m} = \sqrt{\frac{1}{T - 1} {\sum }_{t = 1}^{T} {[ m ( t ) - \overline{m} ]}^{2}}$$

$${b}_{z} ( t ) = \frac{b ( t ) - \overline{b}}{{\hat{σ}}_{b}} where \overline{b} = \frac{1}{T} {\sum }_{t = 1}^{T} b ( t ) and$$

$${\hat{σ}}_{b} = \sqrt{\frac{1}{T - 1} {\sum }_{t = 1}^{T} {[ b ( t ) - \overline{b} ]}^{2}}$$

Because the slope and intercept are correlated, they share a common component to reflect that any change in the slope is inherited by the intercept. There can be separate effects influencing the intercept as well which leads to the following model.

m_{z}=κ+εₘ with εₘ˜N(0,σ_{ε,m}²)

b_{z}=−κ+τ+ε_{b} with ε_{b}˜N(0,σ_{ε,b}²)

The common term, κ, addresses the change in parameters due to score degradation. This is due to market and perhaps other economic forces. The following assumption is made:

κ=ƒ(κ|economy)+ε_{κ} with ε_{κ}˜N(0,σ_{ε,κ}²)

Another term unique to the y-intercept, addresses shifts in the population odds that are not explained by changes in the score distribution. This term captures translations of the odds-to-score line up or down. This effect is also due to market and economic forces. The following assumption is made:

τ=g(τ|economy)+ε_{τ} with ε_{τ}˜N(0,σ_{ε,τ}²)

A set of regression functions, ƒ and g, that explain how the slope and intercept change with respect to economic situations is then determined. An estimate of f is created by studying the correlations between the slope and the economy over time. To estimate, g, however, τ must first be calculated. In order to isolate the translation term, τ, from the observed values of a simple sum is used.

T=m_{z}+b_{z}=(κ+εₘ)+(−κ+τ+ε_{b})=τ+εₘ+ε_{b}

An estimate of τ is obtained by modeling the relationship between τ and the economy over time. Ultimately, this leaves the following tools to forecast the slope and intercept in the log odds to score relationship:

E[m(t)]=E[\hat{σ}ₘm_{z}(t)+ m̅]= σ̅ₘE[m_{z}(t)]+ m̅=\hat{σ}ₘƒ(economy)+ m̅

E[b(t)]=E[\hat{σ}_{b}b_{z}(t)+ b̅]=\hat{σ}_{b}E[b_{z}(t)]+ b̅=\hat{σ}_{b}(−ƒ(economy)+g(economy))+ b̅

As seen from the above example embodiments, estimates of slope and intercept are correlated. There are two methods to resolve or account for the correlation. In a one embodiment, the assumption is that the slope is fixed. The y-intercept is re-estimated subject to a fixed slope and then this is modeled. In other words, the “fixed slope” y-intercept is modeled. In another embodiment, the slope and intercept are both allowed to vary, and these are modeled by transforming the slope and intercept into rotation and translation terms Appling this work in practice has so far demonstrated that the results from these two are close, and therefore the fixed slope assumption seems reasonable. However, the method where the slope is assumed to be constant may be restricted to situations where the slope is in practice seen to be relatively constant over time, and thus the second embodiment may be used or required by bank regulators.

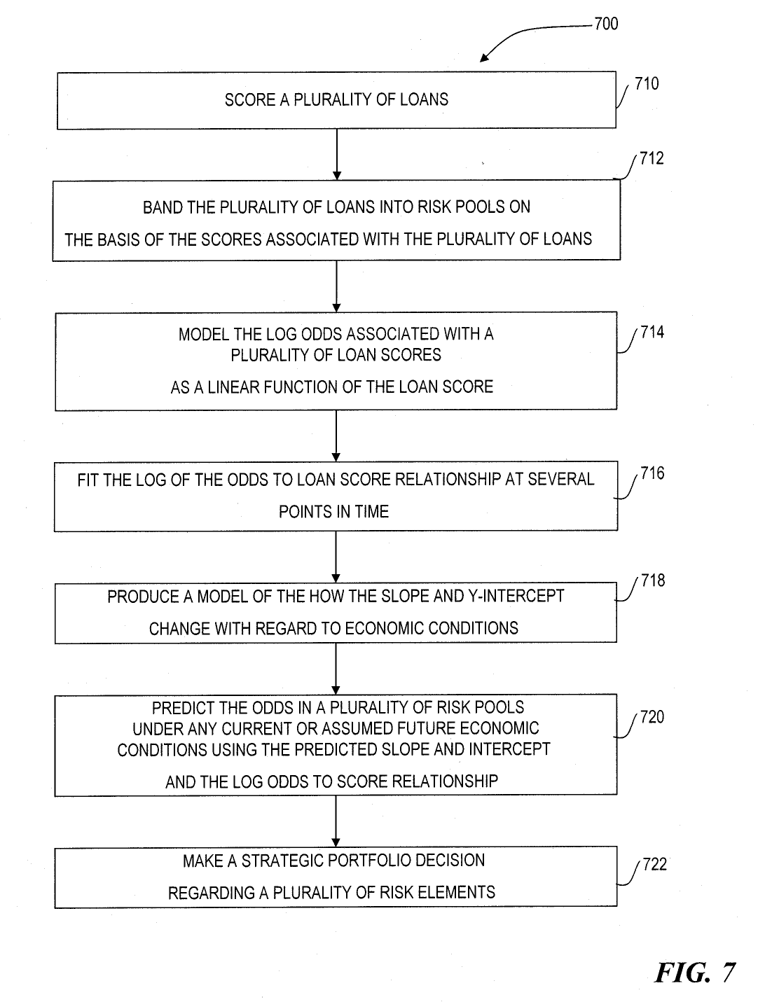

FIG. 7 a computerized method 700 for determining a model used to determine various strategies related to risks, such as determining an amount of capital to hold in reserve for a plurality of loan risk pools, according to still another example embodiment. The method 700 includes scoring a plurality of loans 710, banding the plurality of loans into risk pools on the basis of the scores associated with the plurality of loans 712, and modeling the log odds associated with a plurality of loan scores as a linear function of the loan score 714. The y-intercept and slope of the linear function accounts for changes, including economic changes, that effect the natural log of the odds. The computerized method also includes fitting the log of the odds to loan score relationship at several points in time 716, to obtain intercept and slope statistics at each point in time, producing models of the how the slope and y-intercept change with regard to economic conditions 718, predicting the odds in a plurality of risk pools under any current or assumed future economic conditions using the predicted slope and intercept and the log odds to score relationship 720, and making strategic portfolio decisions 722, such as setting a reserve level for a plurality of risk pools using the predicted log odds to score relationship. Other strategic portfolio decisions that can be made include account acquisitions decisions, prospective odds to score relationship management, account management decisions, and the like. The account management decisions, may also include credit Line Increase/decrease decisions, overlimit and delinquent authorization decisions, and collections and recovery decisions. In some embodiments, producing models of the how the slope changes with regard to economic conditions 718 further includes calculating the average intercept over time, and assuming that this average intercept is a fixed intercept in the odds to score relationship over all points in time. The best fit slope at each point in time using this average intercept is obtained, and the changes in the slope obtained based on this fixed y-intercept are modeled. Thus in this embodiment, the average y-intercept is assumed over time and the changes in the slope of the linear function of the natural log to scores are used to assess risk and determine risk strategies.

Some or all of the functional operations described in this specification can be implemented in digital electronic circuitry, or in computer software, firmware, or hardware, including the structures disclosed in this specification and their structural equivalents, or in combinations of them. Embodiments of the invention can be implemented as one or more computer program products, i.e., one or more modules of computer program instructions encoded on a computer readable medium, e.g., a machine readable storage device, a machine readable storage medium, a memory device, or a machine-readable propagated signal, for execution by, or to control the operation of, data processing apparatus

The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of them. A propagated signal is an artificially generated signal, e.g., a machine-generated electrical, optical, or electromagnetic signal, that is generated to encode information for transmission to suitable receiver apparatus

A computer program (also referred to as a program, software, an application, a software application, a script, an instruction set, a machine-readable set of instructions, or code) can be written in any form of programming language, including compiled or interpreted languages, and it can be deployed in any form, including as a stand alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes, methods, and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for executing instructions and one or more memory devices for storing instructions and data. Generally, a computer will also include, or be operatively coupled to, a communication interface to receive data from or transfer data to, or both, one or more mass storage devices for storing data, e.g., magnetic, magneto optical disks, or optical disks.

Moreover, a computer can be embedded in another device, e.g., a mobile telephone, a personal digital assistant (PDA), a mobile audio player, a Global Positioning System (GPS) receiver, to name just a few. Information carriers suitable for embodying computer program instructions and data include all forms of non volatile memory, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the invention can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments of the invention can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the invention, or any combination of such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

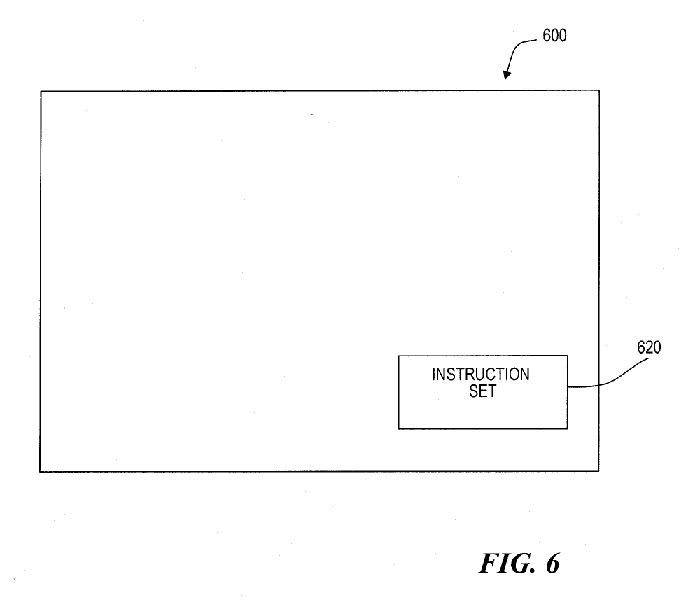

Computer-readable instructions stored in or on a computer-readable medium are executable by a processing unit associated with the system 100. A hard drive, CD-ROM, and RAM are some examples of articles including a computer-readable medium. A machine-readable medium may also include instructions received over the internet of from the world-wide web. FIG. 6 shows a computer or machine-readable medium 600 that includes a set of instructions 620. The machine-readable medium 600 provides instructions 620 that, when executed by a machine, such as system 100, cause the machine to score a plurality of loans, band the plurality of loans into risk pools on the basis of the scores associated with the plurality of loans, and model the log odds associated with a plurality of loan scores as a linear function of the scores of borrowers, from which the odds and the probability of default is calculated. In the model, the y-intercept and slope accounts for changes, including economic changes, that effect the natural log of the odds to the score. The machine readable medium 600 also includes instructions 620 to fit the log of the odds to loan score relationship at several points in time, to obtain intercept and slope statistics for a plurality of points in time, produce a model of the change in intercept and slope over time as a function of a set of macro-economic data, and use the model to predict the intercept and slope under various economic conditions. The instructions 620 also predict the odds in a plurality of risk pools under current economic conditions using the predicted intercept, slope and the log odds to score relationship, relate the log of the odds associated to the loan scores to a probability of default for the plurality of risk pools, and set a reserve level for at least one risk pool. In some embodiments, the instruction 620 that causes the machine to set a reserve level for at least one risk pool includes an instruction to set aside a percentage of the amount of money in the risk pool considered at risk of default. In other embodiments, the instructions 620 that cause the machine to model the odds associated with a plurality of loan scores by using a linear function to relate the natural log of the odds to the score includes an instruction to determine the odds to score relationship on loans in the plurality of risk pools. In still other embodiments, the instructions 620 cause the machine to model the log odds associated with a plurality of loan scores as a linear function of score, includes an instruction to determine the odds to score relationship on loans in each of at least two of the plurality of risk pools. In yet another embodiment, the instruction 620 that causes the machine to relate the natural log of the odds associated to the loan scores to a probability of default for the plurality of risk pools includes further instructions to: adjust the slope and intercept based on the economic factors due to translation and rotation of the log odds to score relationship. The instructions 620 in this embodiment, consider both the rotational effect and translational effect to arrive at a prediction of how both the y-intercept and slope changes with respect to economic factors, such as GDP, unemployment rates, interest rates, and the like.

It should be noted that in many instances, the above example embodiments are applied to setting reserves for a plurality of risk pools. It should be noted that the above embodiments are merely a sampling of how this technique could be applied. The above technique could be used to determine how a projected value of one or more economic factors might change the risk associated with a number of transactions that have been binned, banded or placed in pools. The above technique could then be used to determine actions for managing the risk associated with the number of transactions, such as account acquisitions decisions, prospective odds to score relationship management, account management decisions, and the like. The account management decisions, may also include credit line increase/decrease decisions, overlimit and delinquent authorization decisions, and collections and recovery decisions.

Such embodiments of the inventive subject matter may be referred to herein individually or collectively by the term “invention” merely for convenience and without intending to voluntarily limit the scope of this application to any single invention or inventive concept, if more than one is in fact disclosed. Thus, although specific embodiments have been illustrated and described herein, any arrangement calculated to achieve the same purpose may be substituted for the specific embodiments shown. This disclosure is intended to cover any and all adaptations or variations of various embodiments. Combinations of the above embodiments and other embodiments not specifically described herein will be apparent to those of skill in the art upon reviewing the above description.

The Abstract of the Disclosure is provided to comply with 37 C.F.R. §1.72(b) requiring an abstract that will allow the reader to quickly ascertain the nature of the technical disclosure. It is submitted with the understanding that it will not be used to interpret or limit the scope or meaning of the claims. In the foregoing Detailed Description, various features are grouped together in a single embodiment for the purpose of streamlining the disclosure. This method of disclosure is not to be interpreted to require more features than are expressly recited in each claim. Rather, inventive subject matter may be found in less than all features of a single disclosed embodiment. Thus the following claims are hereby incorporated into the Detailed Description, with each claim standing on its own as a separate embodiment.

What is claimed is:

1. A computerized method comprising:
scoring a plurality of loans;
banding the plurality of loans into risk pools on the basis of the scores associated with the plurality of loans;
modeling the log odds associated with a plurality of loan scores as a linear function of the loan score wherein the y-intercept and slope accounts for changes, including economic changes, that effect the natural log of the odds;
fitting the log of the odds to loan score relationship at several points in time, to obtain intercept and slope statistics at each point in time;
producing models of the how the slope and y-intercept change with regard to economic conditions;
predicting the odds in a plurality of risk pools under any current or assumed future economic conditions using the predicted slope and intercept and the log odds to score relationship; and
setting a reserve level for a plurality of risk pools using the predicted log odds to score relationship.

2. The computerized method of claim 1 wherein producing models of the how the slope and y-intercept change with regard to economic conditions further comprises:
calculating the average slope over time;
assuming that this average slope is a fixed slope in the odds to score relationship over all points in time;
obtaining the best fit intercept at each point in time using this average slope; and
modeling the changes in the y-intercept obtained based on the fixed slope.

3. The computerized method of claim 1 wherein producing models of the how the slope and y-intercept change with regard to economic conditions further comprises:
calculating the average intercept over time;
assuming that this average intercept is a fixed intercept in the odds to score relationship over all points in time;
obtaining the best fit slope at each point in time using this average intercept; and
modeling the changes in the slope obtained based on this fixed y-intercept.

4. The computerized method of claim 1 wherein producing models of the how the slope and y-intercept change with regard to economic conditions further comprises:
translating the slope and intercept changes into translational and rotational changes over time;
modeling of the change in translational and rotational components as a function of a set of macro-economic data;
obtaining the slope and intercept as functions of economic data from the translational and rotational models; and
predicting the intercept and slope under various economic conditions using the model for the change in translational and rotational components as a function of a set of macro-economic data.

5. The computerized method of claim 1 wherein the predicted odds associated with a plurality of loan scores is expressed as a linear function relating the natural log of the odds to a risk score on the loans in the plurality of risk pools.

6. The computerized method of claim 1 wherein fitting the log of the odds to score relationship includes using a linear regression.

7. The computerized method of claim 1 wherein fitting the log of the odds to score relationship includes using a logistic regression.

8. The computerized method of claim 1 wherein the set of macro-economic data includes measures of the Gross Domestic Product (GDP).

9. The computerized method of claim 1 wherein the set of macro-economic data includes a set of interest rates over time.

10. The computerized method of claim 1 wherein the set of macro-economic data includes a set of unemployment rates.

11. The computerized method of claim 1 wherein the set of macro-economic data includes a set of personal savings rates.

12. A machine readable medium that provides instructions that, when executed by a machine, cause the machine to:
score a plurality of loans;
band the plurality of loans into risk pools on the basis of the scores associated with the plurality of loans;
model the log odds associated with a plurality of loan scores as a linear function of the loan score wherein the y-intercept and slope accounts for changes, including economic changes, that effect the natural log of the odds;
fit the log of the odds to loan score relationship at several points in time, to obtain intercept and slope statistics at each point in time;
produce models of the how the slope and y-intercept change with regard to economic conditions;
predict the odds in a plurality of risk pools under any current or assumed future economic conditions using the predicted slope and intercept and the log odds to score relationship; and
set a reserve level for a plurality of risk pools using the predicted log odds to score relationship.

13. The machine readable medium of claim 12 wherein the instructions to model the log odds further cause the machine to:
calculate the average slope over time;
assume that this average slope is a fixed slope in the odds to score relationship over all points in time;
obtain the best fit intercept at each point in time using this average slope; and
model the changes in the y-intercept obtained based on the fixed slope.

14. The machine readable medium of claim 12 wherein the instructions to model the log odds further cause the machine to:
calculate the average intercept over time;
assume that this average intercept is a fixed intercept in the odds to score relationship over all points in time;
obtain the best fit slope at each point in time using this average intercept; and
model the changes in the slope obtained based on this fixed y-intercept.

15. The machine readable medium of claim 12 wherein the instructions to model the log odds further cause the machine to:
translate the slope and intercept changes into translational and rotational changes over time;
model of the change in translational and rotational components as a function of a set of macro-economic data;
obtain the slope and intercept as functions of economic data from the translational and rotational models; and
predict the intercept and slope under various economic conditions using the model for the change in translational and rotational components as a function of a set of macro-economic data.

16. The computerized method of claim 12 wherein the predicted odds associated with a plurality of loan scores is expressed as a linear function relating the natural log of the odds to a risk score on the loans in the plurality of risk pools.

17. A system for determining an amount of capital to hold in reserve for a plurality of loan risk pools, the system comprising:
a first model component for modeling the log odds associated with the plurality of loan scores as a linear function of the loan scores, the y-intercept and slope of the linear function accounting for changes, including economic changes, that effect the natural log of the odds;
a second model component for producing a model of the change in intercept and slope over time as a function of a set of macro-economic data;
a fit component for fitting the log of the odds to loan score relationship at several points in time, to obtain intercept and slope statistics at each point in time; and
a prediction component for predicting the odds in a plurality of risk pools under current or future predicted economic conditions using the predicted intercept and slope and the odds to score relationship; and
a reserve level component for setting a reserve level for at least one risk pool.

18. The system for determining an amount of capital to hold in reserve for a plurality of loan risk pools of claim 17 wherein the reserve level component sets reserve levels in at least two of the plurality of risk pools.

19. A computerized method comprising:
scoring a plurality of loans;
banding the plurality of loans into risk pools on the basis of the scores associated with the plurality of loans;
modeling the log odds associated with a plurality of loan scores as a linear function of the loan score wherein the y-intercept and slope accounts for changes, including economic changes, that effect the natural log of the odds;
fitting the log of the odds to loan score relationship at several points in time, to obtain intercept and slope statistics at each point in time;
producing models of the how the slope and y-intercept change with regard to economic conditions;
predicting the odds in a plurality of risk pools under any current or assumed future economic conditions using the predicted slope and intercept and the log odds to score relationship; and
using the predicted log odds to make strategic portfolio decisions.

20. The computerized method of claim 19 wherein the strategic portfolio decision is to use the expected odds to score relationship to proactively realign the risk score based on this expected odds to score relationship.

21. The computerized method of claim 19 wherein the strategic portfolio decision is to modify acquisition strategies based on the expected future odds to score relationship.

22. The computerized method of claim 19 wherein the strategic portfolio decision is to modify account management strategies.
